(19) United States
(12) Patent Application Publication
(10) Pub. No.: US 2024/0250463 A1
(43) Pub. Date: Jul. 25, 2024

(54) Electrical Plug-in Connection

(71) Applicant: Bayerische Motoren Werke Aktiengesellschaft, Muenchen (DE)

(72) Inventors: Florian BIERWIRTH, Steinhoering (DE); Joachim FROESCHL, Herrsching (DE); Juergen GEBERT, Moosburg (DE)

(21) Appl. No.: 18/564,302

(22) PCT Filed: Apr. 8, 2022
(86) PCT No.: PCT/EP2022/059422

§ 371 Date: Nov. 27, 2023

(30) Foreign Application Priority Data
May 28, 2021 (DE) 10 2021 113 803.5

(51) Int. Cl. H01R 13/193; H01R 13/11; H01R 43/26

(52) U.S. Cl. CPC H01R 13/193; H01R 13/112; H01R 43/26; H01R 2201/26

(57) ABSTRACT

An electrical plug-in connection includes a first plug-in connection element having a plug housing with at least one blade, and a second plug-in connection element having a socket housing with at least one socket in the form of a lamella pair. The lamella pair receives a blade of the first plug-in connection element, wherein the plug-in connection includes a securing element made of a shape memory alloy. The securing element is deformed upon reaching its conversion temperature. The securing element may also exhibit a one-way memory effect, wherein it is brought, after the first and second plug-in connection elements are plugged together, to a temperature which is equal to or greater than its conversion temperature.

### BACKGROUND AND SUMMARY

The present disclosure relates to an electrical plug-in connection comprising a first plug-in connection element with a plug housing in which at least one blade is accommodated, and a second plug-in connection element with a socket housing in which at least one socket in the form of a lamella pair is accommodated, which lamella pair is designed to receive a respective blade of the first plug-in connection element by plugging in. The present disclosure also relates to a method for operating an electrical plug-in connection and to a method for connecting an electrical plug-in connection. The described embodiments can in particular be used advantageously for plug-in connections in vehicles, especially in vehicle on-board power supply systems.

Electrical plug-in connections or plug-in connectors with a first plug-in connection element and a second plug-in connection element, in the case of which the first plug-in connection element and the second plug-in connection element form a force-fitting electrical contact connection in the plugged-in or connected state, are generally known. In the case of a known type of plug-in connection elements, the first plug-in connection element has a housing (“plug housing”) in which at least one metallic blade is accommodated, while the second plug-in connection element has a housing (“socket housing”) in which at least one metallic socket in the form of a lamella pair is accommodated. Often, lamella pairs are surrounded laterally by a typically metallic cage, in that case it even being possible to dispense with a plastics outer housing, in particular if the cage is used as supporting component for the second plug-in connection element.

The lamella pair is designed to receive a respective blade of the plug by plugging in. When the two plug-in connection elements are plugged together, the respective metallic blade is inserted into the associated metallic lamella pair, which is typically curved at the front for reliable insertion of the blade, and in so doing elastically presses the oppositely situated lamellae of the lamella pair apart. The two lamellae then press on either side of the blade when the plug has been plugged in between them, owing to their elastic return force, and produce the force-fitting—and thus redetachable—electrical connection to the blade.

As a result of the requirement for a detachable connection, it is possible for effects that induce deterioration to occur at such plug-in connections and these effects can lead to degradation of the electrical connection between the blade and the lamella pair owing to increased transfer resistance or loosening contact. Such deterioration effects can include a reduction—for example brought about by a relative movement of the two plug-in connection elements owing to external mechanical loading—in the contact force between the blade and the lamella pair, the formation of insulating layers (for example oxide layers) in the contact zone, the development of faults caused for example by locally high flows of current in the contact zone, etc. These phenomena typically cause increased transfer resistance, which in turn can lead to a thermal event, such as arcs, the welding together of the blade and the lamella pair, or even burning down or burning right through of the blade or the lamella pair, or even the destruction of the entire plug-in connection, for example as a result of the housing melting.

A further disadvantage of plug-in connections is that, in the case of plug-in connections, additional requirements are placed on the maximum admissible plug-in forces, these requirements preventing stronger contact forces, thereby in particular limiting the electrical contact properties, and thus making the plug-in connections particularly susceptible to outages caused by deterioration.

The above phenomena are particularly relevant for the supply of safety-relevant loads or functions via a plug-in connection, especially in the case of vehicles. In order to ensure the availability of safety-relevant loads, there are three options which can also be combined: the plug-in connection has a particularly reliable or robust design, the power supply paths for the safety-relevant loads are designed redundantly, and/or a diagnosis concept for monitoring a state of health of the power supply path comprising the plug-in connection is provided. For the robust design of a plug-in connection, in vehicles it is presently known to protect it against deterioration either in the contact plane using material coatings or in the architectural plane using structural approaches (clips, damping grommets, etc.).

One object of the present disclosure is to at least partially overcome the disadvantages of the prior art and to provide a plug-in connection of the type mentioned in the introduction, which has increased reliability and/or robustness.

This object is achieved according to the features of the present disclosure. Further embodiments can also be derived from the present disclosure.

The object is achieved by an electrical plug-in connection comprising a first plug-in connection element with a plug housing in which at least one blade is accommodated, and a second plug-in connection element with a socket housing in which at least one socket in the form of a lamella pair is accommodated, which lamella pair is designed to receive a respective blade of the first plug-in connection element by plugging in, wherein the plug-in connection has at least one structural element (“securing element”) of a shape memory alloy.

This plug-in connection has the advantage that, when a transition temperature at which the securing element deforms by transitioning from its low-temperature phase to its high-temperature phase is reached or exceeded, the securing element can provide an additional mechanical function that increases the operational reliability. Because an increased transfer resistance between the blade and the lamella pair is associated with a higher temperature, the securing element can be “triggered” by the deterioration and the contact between the blade and the lamella pair can be increased further or alternatively activated when the path is switched on. This in turn makes it possible to increase the reliability of the current conduction through the plug-in connection and thus the supply of power in particular for safety-relevant loads. Under certain circumstances, it is even possible not to provide redundant power supply paths and/or complex diagnosis systems and measurement technologies.

A further advantage is that the securing element does not need to be triggered only in the event of deterioration given an excessive temperature of the plug-in connection. Instead, the plug-in connection elements can be plugged in within the maximum plug-in forces admissible up to now if the securing elements are not triggered, and the plug-in connection can accordingly selectively (e.g. in the factory or in a workshop) be heated to its transition temperature and thus reshaped, with the result that a more secure and thus better contact is then already produced during normal (undeteriorated) operation than was achievable to date by maximum admissible plug-in forces. In other words, the advantage emerges that the plug-in connection can be mounted with moderate contact forces, but the electrical contact following the heating of the securing element to its transition temperature during operation is significantly higher. In a further development, the transition temperature is set such that, at typical temperatures when the plug-in connection is being plugged in, the securing element is in its low-temperature phase and still has its initial shape (which can also be referred to as “cold shape”).

It is thus possible to provide an increase, caused by the deformation of the securing element, in the contact force between the blade and the lamella pair in the event of deterioration after startup of the plug-in connection. It is also possible to provide an increase, caused by the deformation of the securing element, in the contact force between the blade and the lamella pair only for better contact before startup of the plug-in connection on a power supply path, it then no longer being possible to react to deterioration after startup. Providing multiple securing elements with different transition temperatures also makes it possible to cover both use cases, that is to say to achieve better contact before startup of the plug-in connection (for example by triggering the reshaping of securing elements with a lower transition temperature) and to provide the deformation of the securing element in the event of deterioration after startup of the plug-in connection (for example by triggering the reshaping of securing elements with a higher transition temperature), as will also be set out in more detail below.

A shape memory alloy can also be referred to as “memory metal”. Shape memory alloys as such are well known and are distinguished in that a cold shape, which is present below the transition temperature, transitions into a geometrically different hot shape upon reaching the transition temperature (which can also be a narrow temperature band).

Shape memory alloys that can be used, for example, are cryogenic materials such as NiTi (nickel-titanium, nitinol) and NiTiCu (nickel-titanium-copper). The transition temperatures can be set via the quantitative ratio: at a nickel content of below 50% atomic percent, it is approximately 100° C. Further copper-based shape memory alloys are, for example, CuZn (copper-zinc), CuZnAl (copper-zinc-aluminum) and CuAlNi (copper-aluminum-nickel). It is also possible to use, for example, FeNiAl (iron-nickel-aluminum), FeMnSi (iron-manganese-silicon) and ZnAuCu (zinc-gold-copper).

In a further development, the transition temperature is set such that it is reached upon appreciable deterioration under typical use conditions.

In a further development, the transition temperature is set such that it is below a destruction temperature of the materials of the plug-in connection or of the connection line, in the case of which these components are not destroyed but can maintain their normal function.

The transition temperature can be set in an installation-space-specific, design-specific and use-specific way. Thus, for example, the transition temperature can be set to approximately 100° C., for example in a range between 90° C. and 120° C., in order to reduce deterioration effects after startup. If, by contrast, the aim is to achieve strong mechanical contact before startup, a lower transition temperature may be advantageous, for example in a range between 50° ° C. and 70° C.

In a further development, at least one securing element exhibits a one-way (memory) effect, which includes a single change in shape when the transition temperature is reached (into the “hot shape”). In the case of the one-way memory effect, the securing element remains in its hot shape even after there is a fall below the transition temperature. It does not return to the cold shape. This can be advantageous in order to prevent multiple changing contact conditions between the blade and the lamella pair, in order to make it easier to look for faults and to be able to permanently increase a contact force after the plug-in connection has been plugged in.

In a further development, at least one securing element exhibits a two-way (memory) effect, which brings about a return to the cold shape with a fall below the transition temperature, possibly with hysteresis.

If the plug-in connection has multiple securing elements, all can exhibit a one-way memory effect, all can exhibit a two-way memory effect, or at least one securing element can exhibit a one-way memory effect and at least one securing element can exhibit a two-way memory effect.

If there is no cage in the second plug-in connection element, the “socket housing” is to be understood to mean in particular the (outer) housing, typically consisting of plastic. If there is a metal cage but no plastics outer housing, the “socket housing” is to be understood to mean in particular the cage. If there is both a plastics outer housing and a cage arranged therein, the “socket housing” is to be understood to mean both the outer housing and the cage.

In a further development, the plug-in connection has multiple securing elements with the same transition temperature. This advantageously also enables complex changes to the mechanical structure of the plug-in connection at the same temperature and thus virtually at the same time.

In a further development, the plug-in connection has at least two securing elements with different transition temperatures. This advantageously enables temperature-dependent, different changes to the mechanical structure of the plug-in connection and thus reactions and/or adaptations to different temperatures in stages. This can be advantageous, for example, in order to selectively trigger securing elements with a lower transition temperature, in order to obtain a high contact force already during normal operation, and accordingly to provide the option of still further improving the contact at even higher transition temperatures brought about by deterioration effects. As a functional equivalent, a securing element may have multiple portions, in particular arranged in series, of shape memory alloys with different transition temperatures which in functional terms can likewise be considered to be securing elements.

In a further development, the first plug-in connection element has at least one securing element.

In an alternative or additional further development, the second plug-in connection element has at least one securing element.

In an alternative or additional further development, the at least one securing element is a standalone securing element which can be inserted in between the two plug-in connection elements when they are being plugged in.

In one embodiment, the at least one securing element changes in shape or deforms (from its cold shape to its hot shape) when heated to its transition temperature such that a contact state between the blade and the lamella pair changes as a result. This affords the advantage that it is possible to react to a generation of heat, which is brought about by deterioration at the contact between the blade and the lamella pair and is transferred at least partially to the securing element, by changing the contact state or the contact conditions, as a result of which contact is then produced without or at least with less deterioration.

The fact that a securing element changes in shape when heated to its transition temperature such that a contact state between the blade and the lamella pair changes as a result can also be expressed to the effect that the at least one securing element is configured (that is to say, set up and designed) to change in shape when heated to its transition temperature such that a contact state between the blade and the lamella pair is changed as a result. The fact that a securing element changes in shape when heated to its transition temperature such that a contact state between the blade and the lamella pair changes as a result can also be expressed to the effect that a securing element changes a contact state between the blade and the lamella pair upon transition into its hot shape. The change in shape is an inherent property of the securing element, since its cold shape and its hot shape are defined by its physical form and its material composition.

In one embodiment, the contact state is a contact pressure (which can also be referred to as pressing-contact pressure) between the blade and the lamella pair, and the at least one securing element is configured to change in shape when heated to its transition temperature such that the contact pressure or the associated contact-pressure force is increased perpendicularly to the contact surface area. This affords the advantage that looser contact brought about by deterioration or a contact surface area that has been reduced by deterioration can be at least partially compensated again by the increased contact pressure and thus the increased normal force between the lamella(e) and the blade.

In a further development, a force and/or a pressure or an increased force is applied by the at least one deformed securing element from the outside to at least one of the lamellae in the direction of the blade. It is advantageous for a symmetrical application of force if a force or increased force is applied to both lamellae by the at least one deformed securing element.

In a further development, the securing element does not apply any force to the at least one lamella in its cold shape, but does so only after transition to the hot shape.

In a further development, the at least one securing element applies a force to the at least one lamella already in the cold shape, and the force intensifies after transition to the hot shape. This can be implemented easily and reliably, for example by virtue of the at least one securing element being in the form of a spring element, as will be described in more detail below.

In an embodiment which is particularly advantageous when there is an (increased) application of force by the securing element in the hot shape, the at least one securing element is arranged between the socket housing (that is to say, the outer housing and/or the cage) and an outer side of at least one lamella of the lamella pair, and the at least one securing element expands at least in the direction between the socket housing and the at least one lamella when the transition temperature is reached and/or upon transition to the hot shape. The socket housing in this case serves as support for the securing element, which then presses the lamella(e) in the direction of the blade. The direction between the socket housing and the at least one lamella can correspond at least approximately to a connection line between the contact regions of a respective securing element with the socket housing and the associated lamella.

In a further development, the securing element in the cold shape contacts the outer side of the lamella. This affords the advantage that, in the hot shape, particularly high forces can be exerted on the lamella, a particularly compact arrangement is obtained and mounting is particularly straightforward.

In a further development, the securing element in the cold shape is at a distance from the outer side of the lamella(e) and only contacts the outer side of the lamella(e) with transition to the hot shape. This affords the advantage that the lamellae can be bent apart particularly easily when the blade is being inserted into the lamella pair at which the securing element is in its cold shape, without this being impeded by the securing element.

As an alternative, the at least one securing element may be mounted on a respective outer side of the lamella and then, in the cold shape, either make contact with the socket housing in a force fit or move away from the socket housing, which is counteracted only in the hot shape.

In a further development, for each lamella of the lamella pair at least one securing element is arranged between the socket housing and the lamella. This enables a particularly straightforward and reliable arrangement.

In one embodiment, for each lamella of the lamella pair multiple securing elements are arranged between the socket housing and the associated lamella. This advantageously makes it possible to use individual securing elements with a particularly straightforward construction and/or to apply particularly high forces. The securing elements may be arranged in series and/or next to one another.

In one embodiment, at least two of the multiple securing elements arranged in series have different transition temperatures. This affords the advantage that the contact pressure can be increased in stages depending on the temperature. As an alternative, it is possible to use a one-piece securing element of which at least two portions, arranged one behind the other, have a different transition temperature.

In one embodiment, the blade is a split blade, the two arms of which in the plugged-in state contact a respective lamella of the lamella pair, and at least one securing element is arranged between the two arms and is configured to press the arms apart when the transition temperature is reached. This can be implemented in particularly compact fashion. In this respect, it is expedient if the arms can be plugged in between the lamellae of the lamella pair at least when the at least one securing element is still in the cold state. This can be achieved by a corresponding dimensioning of the distance between the arms in relation to a bent-open shape of the lamellae at their front edge. If multiple securing elements are present, they can have the same or different transition temperatures.

In a further development, the securing element is in the form of a helical spring which elongates upon transition to the hot shape. This can be implemented particularly easily. However, the securing element may also take any other shape suitable as a spring element, for example having an annular shape, the diameter of which increases at least in one direction upon transition to the hot shape, having the form of a torsion spring, a bending beam or a wavy plate, etc.

In one embodiment, the at least one securing element is embedded in the socket housing, the socket housing is connected at least by a force fit to the outer side of at least one of the lamellae via at least one force transmission element, and the at least one securing element is deformable or deforms (or is configured to do so) when the transition temperature is reached, such that the socket housing bends inward at the location of the force transmission element. This affords the advantage that the second plug-in connection element can be formed particularly easily inside the socket housing. For example, mounted on the outer side of at least one lamella can be a force transmission element, for example in the form of a stiff push rod or a spring element, which contacts the socket housing at least when the blade is plugged in. Upon transition to the hot shape, the socket housing presses the force transmission element onto the outer side of the lamella(e).

In one embodiment, the contact state is a position of the blade in the lamella pair and the at least one securing element changes in shape when heated to at least one transition temperature such that a distance between the first plug-in connection element and the second plug-in connection element changes. This affords the advantage that the contact pressure on the lamella pair does not need to be changed. Instead, the contact surface area of the blade that makes contact with the lamella pair is displaced relative to the lamella pair, with the result that possible impairment of the transfer resistance owing to faults in the contact surface area of the blade can be eliminated by using a “fresh” contact surface area on the blade.

In one configuration, the at least one securing element is arranged between the plug housing and the socket housing and is configured to change in shape when heated to its transition temperature and/or upon transition to its hot shape such that a force is exerted on the housing along a plug-in direction. This affords the advantage that the first plug-in connection element and the second plug-in connection element are displaced with respect to one another along the plug-in direction and thus the blade is also displaced relative to the lamella pair. In addition, this embodiment can be implemented particularly easily. Exerting a force “along a plug-in direction” can be understood to mean exerting a force “in a plug-in direction,” the force guiding the two housings back together. Exerting a force “along a plug-in direction” can, however, also be understood to mean exerting a force “counter to the plug-in direction,” the force moving the two housings apart again.

In a further development, the multiple securing elements are arranged between the plug housing and the socket housing, this advantageously enabling a particularly reliable relative movement of the housings in relation to one another. As an alternative, for example a single securing element in the form of a wavy plate that changes its waviness or height between the cold shape and the hot shape can be arranged between the two housings.

In one embodiment, the at least one securing element is arranged between the plug housing and the socket housing and is configured to change in shape when heated to its transition temperature such that it exerts a force on the housings counter to the plug-in direction. This at least partially presses the two housings apart. The blade is then correspondingly at least partially pulled out of the lamella pair. A further development that can be implemented particularly easily is that the at least one securing element elongates or expands along the plug-in direction upon transition to its hot shape.

In a further development, the at least one securing element is configured to change in shape when heated to its transition temperature such that the blade is separated from the lamella pair. This affords the advantage that destruction of the plug-in connection can be prevented particularly reliably.

In a further development, multiple securing elements are arranged between the plug housing and the socket housing and change in shape when heated to their respective transition temperature such that they exert a force on the housings counter to the plug-in direction in order to move the housings apart, and at least two of the securing elements have different transition temperatures. This affords the advantage that, in a further development, upon reaching the lower transition temperature the housings are moved apart only to an extent that the blade remains in contact with the lamella pair and then, upon reaching the higher transition temperature, the housings are moved apart to the extent that the contact between the blade and the lamella pair is lost.

In a further development, the at least one securing element is arranged between the plug housing and the socket housing and exerts a force in the plug-in direction upon transition to its hot shape and thus at least partially draws the two housings together and as a result moves them back toward one another. The blade is then correspondingly plugged back into the lamella pair. In a further development of this which is particularly easy to implement, the at least one securing element contracts or shortens along the plug-in direction upon transition to its hot shape. As a result, it can draw the two housings back together, in particular if it is fastened to the two housings by a form fit or an integral bond.

In one embodiment, the at least one securing element is in the form of a spring element. This affords the advantage, among other things, that the function of the blade and/or the lamella pair is only slightly impaired to virtually not impaired at all. In a particularly advantageous further development, the securing element is in the form of a spring element both in its cold shape and in its hot shape. In a further development, a spring constant of the securing element is lower in the cold shape than in the hot shape, that is to say the securing element is softer in the cold shape. This may be advantageous in order to be able to exert particularly high forces upon and after transition to the hot shape. However, the reverse case is also possible.

In one embodiment, the securing element is arranged on an outer side of the plug housing and/or of the socket housing and is deformable or deforms into a shape which protrudes from the respective housing when heated to its transition temperature. In other words, the securing element is configured to protrude out of the housing to a greater extent in its hot shape than in its cold shape. This affords the advantage that the triggering of the securing element owing to the generation of a high temperature at the plug-in connection can be easily detected, and therefore visually diagnosed, from the outside. In a further development, the securing element in its cold shape does not protrude from the housing, but instead is for example completely embedded therein. In this embodiment, the securing element advantageously has a one-way memory effect.

The object is also achieved by an on-board power supply system for vehicles that has at least one such plug-in connection. The on-board power supply system can be designed analogously to the plug-in connection and has the same advantages.

In a further development, the on-board power supply system has an electrical power supply path which has such a plug-in connection at least at one end. To that end, for example, a cable having the first or the second plug-in connection element at least at one end may be provided. Specifically, the power supply path can connect a power distributor to an electrical load, in particular a safety-relevant electrical load, such as electric power steering, an electrical brake system, etc.

The object is also achieved by a vehicle having such an on-board power supply system. The vehicle may comprise a combustion engine or a hybrid drive or be a fully electric vehicle. The vehicle may in particular be an autonomous vehicle. However, the plug-in connection is not restricted to vehicles and instead can be used for all types of power supply systems in which power supply paths with high availability are desirable, for example in the fields of industry, shipping, aeronautics, medical technology, etc.

The object is also achieved by a method for operating an electrical plug-in connection as described above, in the case of which the securing element deforms from its cold shape to its hot shape upon reaching its transition temperature. The method may be designed analogously to the plug-in connection and has the same advantages.

The object is also achieved by a method for connecting an electrical plug-in connection as described above, in the case of which the at least one securing element exhibits a one-way memory effect and, after the first plug-in connection element is plugged into the second plug-in connection element, is brought to a temperature which is the same as or higher than the transition temperature of the at least one securing element.

This method makes use of the fact that not only does the “triggering” of the securing element need to be carried out only in the event of excessive temperature of the plug-in connection, and the contact is further improved only then, but also a more secure and thus better contact can also be produced by selectively heating the securing element to its transition temperature, for example in the factory or in a workshop. This affords the advantage that the plug-in connection can be mounted with moderate contact forces, but the electrical contact following the heating of the securing element to its transition temperature is considerably higher during operation.

The above-described properties, features and advantages of this disclosure and the way in which they are achieved will become more clearly understandable in conjunction with the following schematic description of an exemplary embodiment, which will be explained in more detail in conjunction with the drawings.

### BRIEF DESCRIPTION OF THE DRAWINGS

FIG. 1 shows a sectional illustration in a side view of a sketch of a plug-in connection according to the prior art in its plugged-in state;

FIG. 2 shows a sectional illustration in a side view of a sketch of a plug-in connection according to a first exemplary embodiment in its plugged-in state with securing elements in their cold shape;

FIG. 3 shows a sectional illustration in a side view of a sketch of the plug-in connection according to the first exemplary embodiment in its plugged-in state with securing elements in their hot shape;

FIG. 4 shows a sectional illustration in a side view of a sketch of a plug-in connection according to a second exemplary embodiment in its plugged-in state with securing elements in their cold shape;

FIG. 5 shows a sectional illustration in a side view of a sketch of the plug-in connection according to the second exemplary embodiment in its plugged-in state with securing elements in their hot shape;

FIG. 6 shows a sectional illustration in a side view of a sketch of a plug-in connection according to a third exemplary embodiment in its plugged-in state with a securing element in its cold shape;

FIG. 7 shows a sectional illustration in a side view of a sketch of the plug-in connection according to the third exemplary embodiment in its plugged-in state with the securing element in its hot shape;

FIG. 8 shows a sectional illustration in a side view of a sketch of a plug-in connection according to a fourth exemplary embodiment in its plugged-in state with two securing elements in their cold shape;

FIG. 9 shows a sectional illustration in a side view of a sketch of the plug-in connection according to the fourth exemplary embodiment in its plugged-in state with a securing element in its cold shape and a securing element in its hot shape;

FIG. 10 shows a sectional illustration in a side view of a sketch of the plug-in connection according to the fourth exemplary embodiment in its plugged-in state with both securing elements in their hot shape;

FIG. 11 shows a sectional illustration in a side view of a sketch of a plug-in connection according to a fifth exemplary embodiment in its plugged-in state with securing elements in their cold shape;

FIG. 12 shows a sectional illustration in a side view of a sketch of the plug-in connection according to the fifth exemplary embodiment in its plugged-in state with the securing elements in their hot shape;

FIG. 13 shows a sectional illustration in a side view of a sketch of a variant of the plug-in connection according to the fifth exemplary embodiment in its plugged-in state with the securing elements in their hot shape;

FIG. 14 shows a sectional illustration in a side view of a sketch of a plug-in connection according to a sixth exemplary embodiment in its plugged-in state with a securing element in its cold shape;

FIG. 15 shows a sectional illustration in a side view of a sketch of the plug-in connection according to the fifth exemplary embodiment in its plugged-in state with the securing element in its hot shape; and

FIG. 16 shows a sectional illustration in a side view of a sketch of a variant of the plug-in connection according to the first exemplary embodiment in its plugged-in state with securing elements in their cold shape.

### DETAILED DESCRIPTION OF THE DRAWINGS

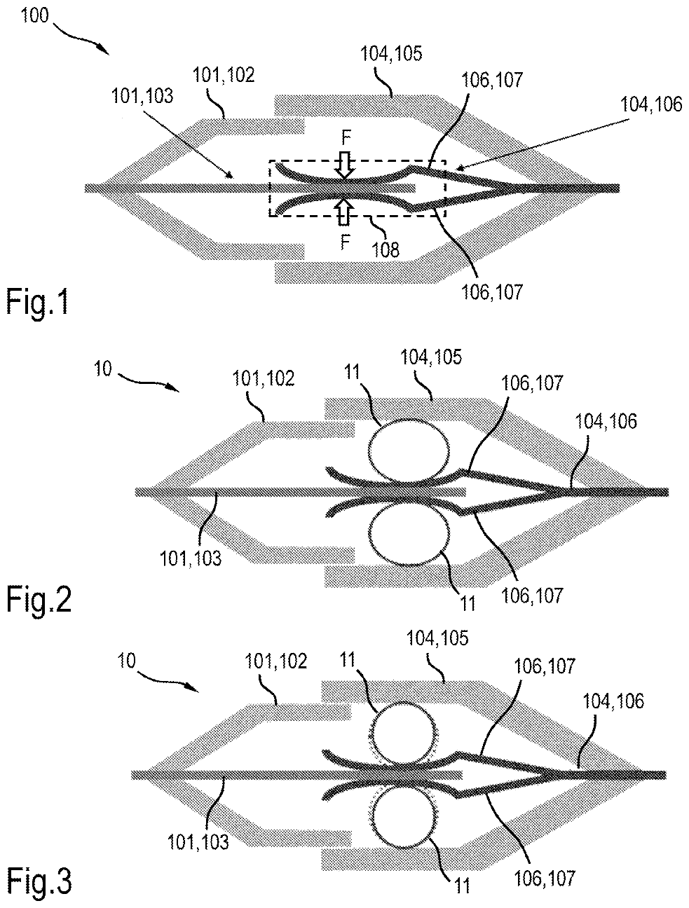

FIG. 1 shows a sectional illustration in a side view of a sketch of a plug-in connection 100 according to the prior art in its plugged-in state. The plug-in connection 100 has a first plug-in connection element 101 with a plug housing 102 in which a metallic blade 103 is accommodated. The plug-in connection 100 also has a second plug-in connection element 104 with a socket housing 105 in which a socket in the form of a metallic lamella pair 106 is accommodated. The socket housing 105 is sketched purely by way of example here as a plastics outer housing, it being possible alternatively or additionally for the lamella pair 106 to be surrounded by a metallic cage 108 which is in the form of the socket housing and is open to the front.

In the plugged-in state, the blade 103 is plugged in between the two lamellae 107 of the lamella pair 106. The lamellae 107 were elastically bent open when the blade 103 was being plugged in and exert a respective opposing spring force on the blade 103 owing to the elastic springback, the spring force at least approximately corresponding to the contact pressure F on the blade 103 in the normal direction of the contact surface area.

FIG. 2 shows a sectional illustration in a side view of a sketch of a plug-in connection 10 according to a first exemplary embodiment in its plugged-in state with securing elements 11 in their cold shape. The plug-in connection 10 has the same basic structure as the plug-in connection 100, but additionally has the securing elements 11, which are arranged between the socket housing 105 and an outer side of a respectively assigned lamella 107. In this figure and in the following figures up to FIG. 15, the device is described only with reference to the outer socket housing 105, which includes the option of using the cage 108, instead of the socket housing 105 or in addition to the socket housing 105, in a functionally similar way.

The securing elements 11 are in the form of spring elements and specifically take a ring shape here purely by way of example. They contact the inner wall of the socket housing 105 and, on their opposite portion, the lamellae 107. The formation of the securing elements 11 as spring elements does not or does not noticeably hinder the plugging in of the blade 103, since the securing elements 11 yield when the lamellae 107 are bent back.

The securing elements 11 may be present with equivalent functions but also a different shape, for example in the form of helical springs.

FIG. 3 shows a sectional illustration in a side view of a sketch of the plug-in connection 10 with the securing elements 11 in their hot shape. The hot shape is taken on after the transition temperature is exceeded and can either remain after a subsequent fall below the transition temperature (one-way memory effect) or return to the cold shape (two-way memory effect).

The hot shape differs from the cold shape in that the securing elements 11 expand at least along the connection line between their contact portions with the socket housing 105 and the lamellae 107, as indicated by the dotted lines. Since, in addition, the spring constant of the hot shape is not below the spring constant of the cold shape here, a force exerted from the outside by the securing elements 11 on the lamellae 107 is thereby increased, as a result of which the contact pressure or the contact-pressure force F of the lamellae 107 on the blade 103 is increased. This makes it possible for example to reduce or alleviate the effect of deterioration effects on the transfer resistance between the blade 103 and the lamellae 107.

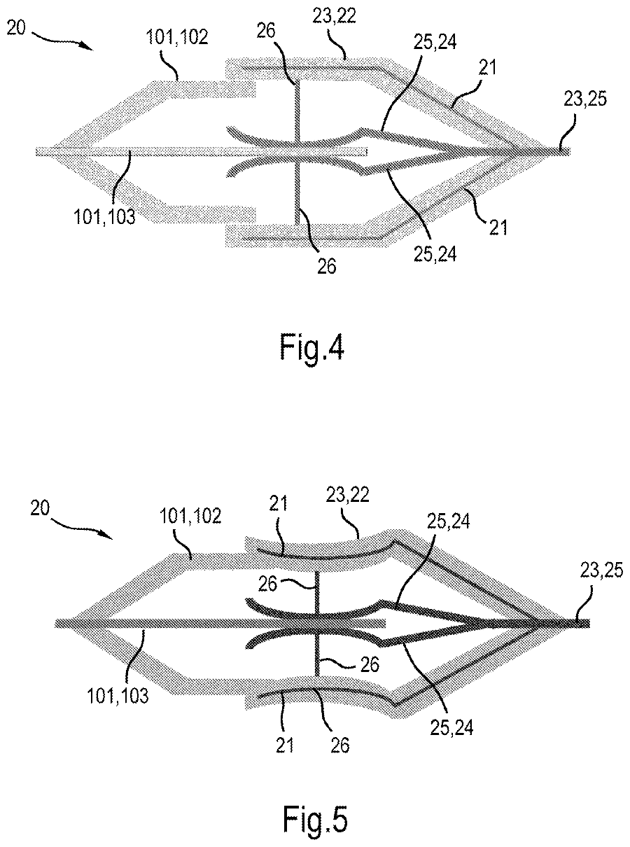

FIG. 4 shows a sectional illustration in a side view of a sketch of a plug-in connection 20 according to a second exemplary embodiment in its plugged-in state with securing elements 21 in their cold shape. The securing elements 21 are embedded on opposite sides of a socket housing 22 of a second plug-in connection element 23. In all other respects, the second plug-in connection element 23 has a similar structure to the second plug-in connection element 104.

The lamellae 24 of the lamella pair 25 have the same basic shape as the lamellae 107, although now, in addition, on their outer side a respective force transmission element 26 is mounted, here in the form of a spring element, which contacts the opposite inner wall of the socket housing 23 when the blade 107 is plugged in, the securing elements 21 also being located in this region. The force transmission elements 26 are thus supported on the securing elements 21 via the socket housing 23.

If the blade 103 is not plugged in the lamella pair 25, the force transmission elements 26 may be at a distance from the socket housing 23, this also making it easier to mount them. The force transmission elements 26 may also be in the form of stiff push rods instead of spring elements.

FIG. 5 shows a sectional illustration in a side view of a sketch of the plug-in connection 20 with the securing elements 26 in their hot shape. In the hot shape, the securing elements 26 are bent inward, that is to say in the direction of the opposite lamella 24, at least in the region where the force transmission element 26 makes contact. This causes the socket housing 22 to press the lamellae 24 against the blade 103 via the force transmission elements 26, as a result of which the contact pressure F increases.

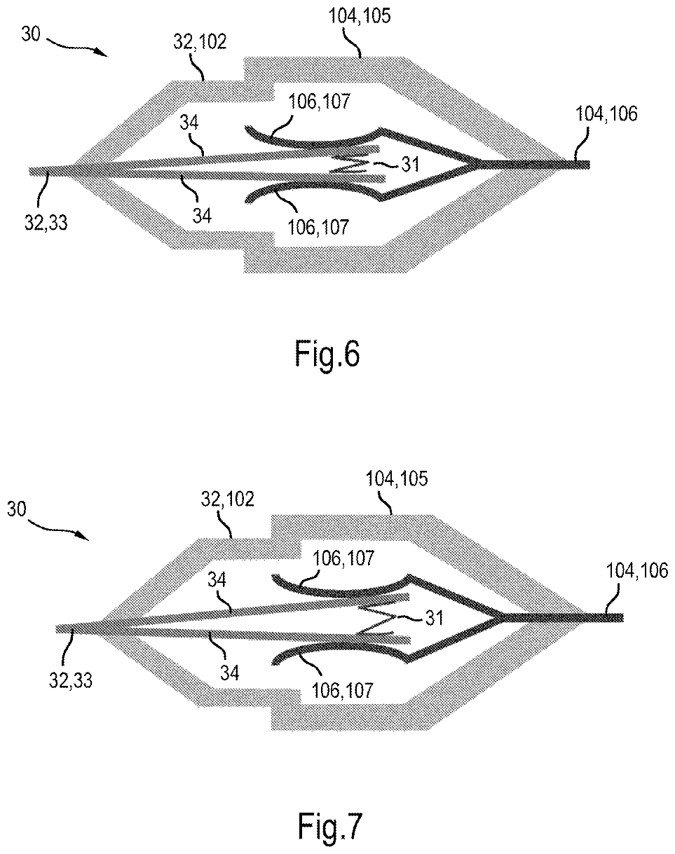

FIG. 6 shows a sectional illustration in a side view of a sketch of a plug-in connection 30 according to a third exemplary embodiment in its plugged-in state with a securing element 31 in its cold shape. The second plug-in connection element 104 of the plug-in connection 30 corresponds to a conventional second plug-in connection element 104.

The first plug-in connection element 32, in its plug housing 102, has a split blade 33, between the two diverging arms 34 of which the securing element 31 in the form of a spring element is arranged. The lamella pair 106 is dimensioned such that the blade 32 can be plugged in without problems. In the plugged-in state, the arms 34 press on the inner sides of respective contacted lamellae 107.

Instead of the one securing element 31, it is also possible to arrange multiple securing elements 31 in series and/or next to one another between the arms 34, these securing elements optionally also being able to have different transition temperatures.

FIG. 7 shows a sectional illustration in a side view of a sketch of the plug-in connection 30 with the securing element 31 in its hot shape. In the hot shape, the securing element 31 has elongated in relation to its cold shape in the direction between the arms 34, with the result that it then presses the blades 34 apart (to a greater extent) than in the cold shape. This increases the contact force between the blades 34 and the respective lamellae 107.

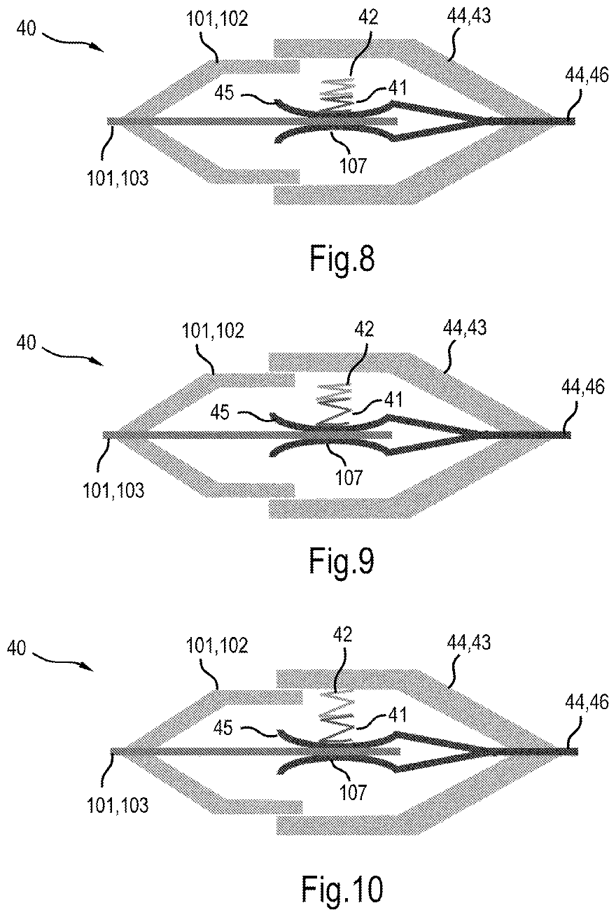

FIG. 8 shows a sectional illustration in a side view of a sketch of a plug-in connection 40 in its plugged-in state with two securing elements 41 and 42 in their cold shape. The securing elements 41 and 42, similarly to the case of the plug-in connection 10, are located in the socket housing 43 of the second plug-in connection element 44, and specifically are mounted on an outer side of one of the two lamellae 45 of the lamella pair 46. The securing elements 41, 42 have different transition temperatures, namely here, purely by way of example, the securing element 41 has a lower transition temperature and the securing element 42 has a higher transition temperature. When the respective transition temperatures are reached, the securing elements 41, 42 each expand in the longitudinal direction.

The securing elements 41, 42, which in particular are in the form of spring elements, are illustrated arranged in series here. As an alternative, instead of two securing elements 41, 42, it is possible to use a one-piece securing element which has two longitudinal portions which have different transition temperatures and can be considered to be functionally different securing elements 41, 42.

Furthermore, in the present case the securing elements 41, 42 are illustrated such that they do not contact the socket housing 43 in the cold shape shown. As an alternative, they may already contact the socket housing 43 in their cold shape, for example in a similar way as described for the plug-in connection 10.

In the present case, the securing elements 41 and 42 are in addition depicted mounted only on one lamella 45, but securing elements 41, 42 may likewise be mounted on the other lamella 107 in the same way.

FIG. 9 shows a sectional illustration in a side view of a sketch of the plug-in connection 40 with the securing element 41 in its hot shape and the securing element 42 in its cold shape. As a result, the securing element 42 moves close to the socket housing 43.

In the case which is not depicted, that of the securing elements 41, 42 already contacting the socket housing 43 in their cold shape, the contact force between the lamella 45 and the blade 103 is thus increased. This may be advantageous, for example, in order to selectively increase the contact force already before use in normal operation, for example by heat treatment in the factory or in a workshop.

FIG. 10 shows a sectional illustration in a side view of a sketch of the plug-in connection 40 with both securing elements 41, 42 in their hot shape. As a result, the securing element 42 now contacts the socket housing 4, as a result of which the contact force between the lamella 45 and the blade 103 is increased.

In the case which is not depicted, that of the securing elements 41, 42 already contacting the socket housing 43 in their cold shape, the contact force between the lamella 45 and the blade 103 is thus increased still further. This may be advantageous, for example, in order additionally to improve the state of health of the contact between the blade 103 and the lamella 45 in the event of deterioration of the contact surface area.

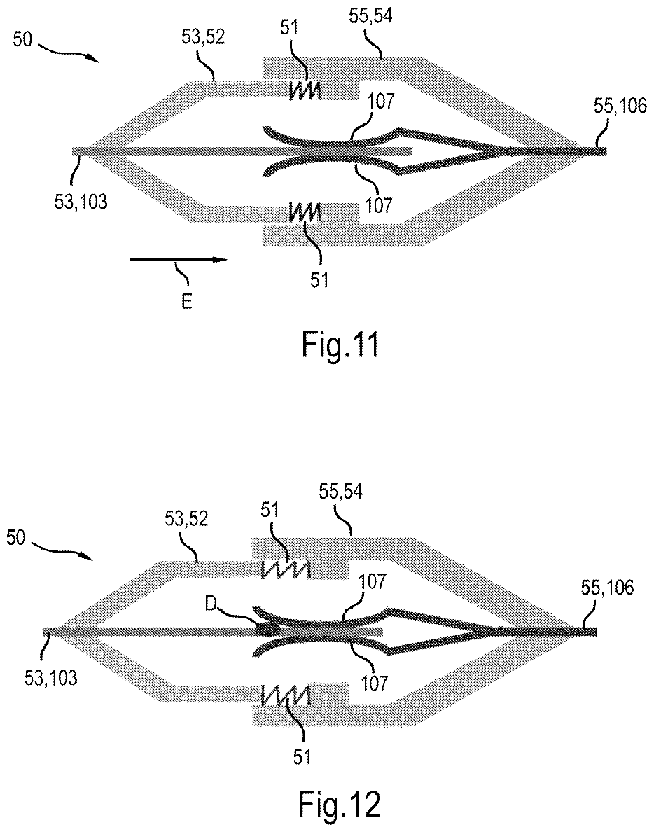

FIG. 11 shows a sectional illustration in a side view of a sketch of a plug-in connection 50 according to a fifth exemplary embodiment in its plugged-in state with securing elements 51 in their cold shape. The securing elements 51, which are optionally in the form of spring elements, are now arranged between the plug housing 52 of the first plug-in connection element 53 and the socket housing 54 of the second plug-in connection element 55, specifically in such a way that they are supported at the ends on the two housings 53, 55.

FIG. 12 shows a sectional illustration in a side view of a sketch of the plug-in connection 50 with the securing elements 51 in their hot shape. In the hot shape, the securing elements 51 have expanded along the plug-in direction E, depicted here in relation to the plug housing 53, with the result that they exert a force on the housings 53, 55 counter to the respective plug-in directions E and press the housings 53, 55 apart as a result. Consequently, the blade 103 is drawn out of the lamella pair 106 but still remains in contact therewith, specifically advantageously with the same contact surface area.

This makes it possible to remove fault locations D, created by deterioration and depicted here by way of indication, in the blade 107 on the original contact surface area upon transition to the hot shape from contact with the lamellae 107, and the new contact surface area has less or even no longer has any fault locations D.

The reverse case can also be implemented, in the case of which FIG. 12 shows the securing elements 51 in their cold shape, and the securing elements 51 contract or constrict along the plug-in direction E upon transition to the hot shape. This causes a force to be exerted on the housings 53 and 55 in their respective plug-in directions E, and the force moves the housings 53 and 55 close to one another. In that case, FIG. 11 shows the plug-in connection 50 with the securing elements 51 in their hot shape. By moving the housings 53 and 55 closer together still, the blade 103 is pushed further into the lamella pair 106 upon transition to the hot shape. This also makes it possible to remove fault locations D, created by deterioration, in the blade 107 on the original contact surface area upon transition to the hot shape from contact with the lamellae 107.

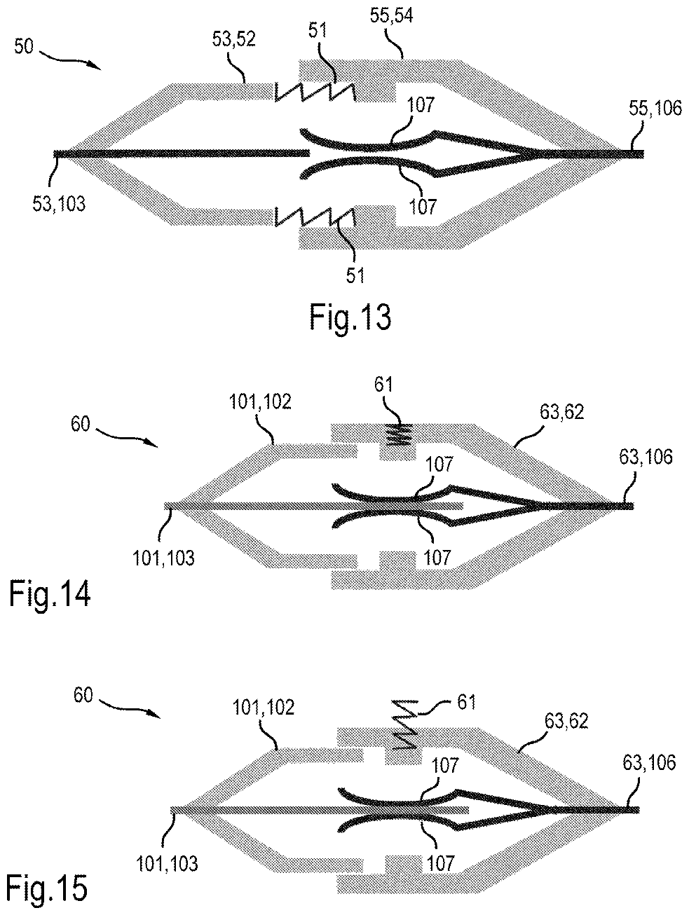

FIG. 13 shows a sectional illustration in a side view of a sketch of a variant of the plug-in connection 50 with the securing elements 51 in their hot shape, which they were brought into proceeding from the plug-in connection 50 shown in FIG. 11. The elongation, created by the transition from the cold shape to the hot shape, of the securing elements 51 along the plug-in direction E is large enough here that the blade 103 is slid completely out of the lamella pair 106 and the contact between them has been interrupted as a result.

It is also possible to design the securing elements 51 similarly to the securing elements 41 and 42, with two longitudinal portions having different transition temperatures, with the result that, upon reaching the lower transition temperature, proceeding from the cold shape shown in FIG. 11 first of all the arrangement shown in FIG. 12 is taken on. If this is not enough and the deterioration leads to a further temperature increase, the contact is interrupted as shown in FIG. 13 upon reaching the higher transition temperature.

FIG. 14 shows a sectional illustration in a side view of a sketch of a plug-in connection 60 according to a sixth exemplary embodiment in its plugged-in state with a securing element 61 in its cold shape. The securing element 61 is embedded in the socket housing 62 on an outer side of the socket housing 62 of the second plug-in connection element 63, specifically such that it does not protrude from the socket housing 62 in its cold shape.

FIG. 15 shows a sectional illustration in a side view of a sketch of the plug-in connection 60 with the securing element in its hot shape. Upon transition to the hot shape, the securing element 61 expands such that it now protrudes from the socket housing 62 and as a result can be clearly seen when the plug-in connection is observed visually. This securing element 61 thus serves as an indicator for an excessive temperature at the plug-in connection 60. This makes it easier to look for faults or perform diagnosis.

The securing element 61 can consist of a shape memory alloy with a one-way memory effect or a two-way memory effect.

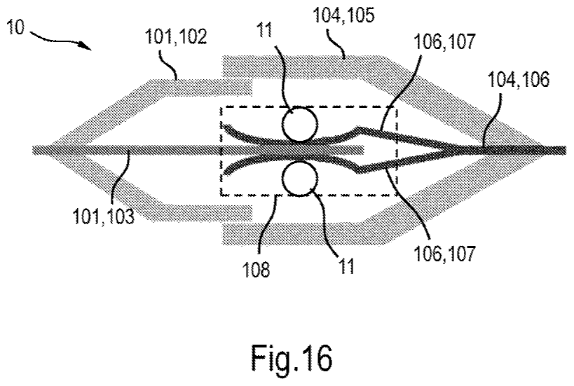

FIG. 16 shows a sectional illustration in a side view of a sketch of a variant of the plug-in connection 10 with the securing elements 11 in their cold shape. Here, a cage 108 is now present in addition to the outer housing 105. Similarly to FIG. 2, the securing elements 11 are now supported, in a functionally similar way, on the cage 108 and not on the outer housing 105. It is even possible to omit the outer housing 105.

The plug-in connections 10, 20, 30, 40, 50 and 60 can in particular be used in vehicle on-board power supply systems, specifically with connection cables via which safety-relevant electrical loads of the vehicle can be supplied with power.

The present disclosure is not restricted to the exemplary embodiment shown.

The various embodiments can also be combined. For example, the securing element 61 may also be used in the plug-in connections 10, 20, 30, 40 and 50. It is also possible, for example, for the blade 33 of the plug-in connection 30 to be used together with the plug-in connections 10, 20 and 40, etc.

In FIG. 2 to FIG. 15, it is also possible to use a cage 108, in a functionally similar way to the outer housing 105, instead of or in addition to the outer housing 105.

In general, “one”, “a”, etc. can be understood to mean a singular or a plural, in particular within the meaning of “at least one” or “one or more”, etc., provided this is not explicitly excluded, for example by the expression “exactly one”, etc.

A numerical indication may also comprise the indicated number exactly and also a customary tolerance range, provided this is not explicitly excluded.

### LIST OF REFERENCE SIGNS

10 Plug-in connection
11 Securing element
20 Plug-in connection
21 Securing element
22 Socket housing
23 Second plug-in connection element
24 Lamella
25 Lamella pair
26 Force transmission element
30 Plug-in connection
31 Securing element
32 First plug-in connection element
33 Blade
34 Arm
40 Plug-in connection
41 Securing element
42 Securing element
43 Socket housing
44 Second plug-in connection element
45 Lamella
46 Lamella pair
50 Plug-in connection
51 Securing element
52 Plug housing
53 First plug-in element
54 Socket housing
55 Second plug-in element
60 Plug-in connection
61 Securing element
62 Socket housing
63 Second plug-in connection element
100 Plug-in connection
101 First plug-in connection element
102 Plug housing
103 Blade
104 Second plug-in connection element
105 Socket housing
106 Lamella pair
107 Lamella
108 Cage
D Fault location
E Plug-in direction
F Contact pressure

1-15. (canceled)

16. An electrical plug-in connection comprising:
a first plug-in connection element with a plug housing, wherein the plug housing comprises at least one blade;
a second plug-in connection element with a socket housing, wherein the socket housing comprises at least one socket in the form of a lamella pair;
at least one securing element made of a shape memory alloy,
wherein the lamella pair is configured to receive a respective blade of the first plug-in connection element by plugging in.

17. The electrical plug-in connection according to claim 16, wherein the at least one securing element changes in shape in response to being heated to its transition temperature such that a contact state between the blade and the lamella pair changes as a result.

18. The electrical plug-in connection according to claim 17, wherein the contact state is a contact pressure between the blade and the lamella pair, and the at least one securing element is configured to change in shape in response to being heated to its transition temperature such that the contact pressure is increased.

19. The electrical plug-in connection according to claim 18, wherein the at least one securing element is arranged between the socket housing and an outer side of at least one lamella of the lamella pair, and the at least one securing element expands in a direction between the socket housing and the at least one lamella in response to its transition temperature being reached.

20. The electrical plug-in connection according to claim 19, wherein for each lamella of the lamella pair, multiple securing elements are arranged in series between the socket housing and a lamella of the lamella pair.

21. The electrical plug-in connection according to claim 20, wherein at least two of the multiple securing elements arranged in series have different transition temperatures.

22. The electrical plug-in connection according to claim 17, wherein:
the blade is a split blade comprising two arms,
wherein the contact state of the two arms of the blade is in contact with a respective lamella of the lamella pair, and
wherein at least one securing element is arranged between the two arms and is configured to press the arms apart in response to reaching a respective transition temperature.

23. The electrical plug-in connection according to claim 17, wherein:
the at least one securing element is embedded in the socket housing, and
wherein the socket housing is connected to an outer side of at least one of the lamellae of the lamella pair via at least one force transmission element, and
wherein the at least one securing element is configured to change in shape in response to reaching its transition temperature such that the at least one securing element bends the socket housing inward at the location of the force transmission element.

24. The electrical plug-in connection according to claim 17, wherein the contact state is a position of the blade between the lamella pair, and wherein the at least one securing element is configured to change in shape in response to being heated to its transition temperature such that a distance between the first plug-in connection element and the second plug-in connection element changes.

25. The electrical plug-in connection according to claim 24, wherein the at least one securing element is arranged between the plug housing and the socket housing, and wherein the at least one securing element is configured to change in shape in response to being heated to its transition temperature such that it exerts a force on the housings along a plug-in direction.

26. The electrical plug-in connection according to claim 24, wherein the at least one securing element is arranged between the plug housing and the socket housing and changes in shape in response to being heated to its transition temperature such that it exerts a force on the housings in or counter to a plug-in direction.

27. The electrical plug-in connection according to claim 16, wherein the at least one securing element is in the shape of a spring.

28. The electrical plug-in connection according to claim 16, wherein the at least one securing element is arranged on an outer side of the plug housing and/or an outer side of the socket housing, and is configured to deform into a shape that protrudes from the plug housing and/or socket housing in response to being heated to its transition temperature.

29. A method for operating an electrical plug-in connection comprising:
plugging in a first plug-in connection element into a second plug-in connection element;
bringing an at least one securing element made of a shape memory alloy to its transition temperature;
wherein the at least one securing element deforms from a cold shape to a hot shape upon reaching its transition temperature.

30. The method of claim 29, wherein the at least one securing element exhibits a one-way memory effect.

31. The method of claim 29 further comprising:
Increasing a contact pressure between the lamella pair in response to the at least one securing element being in its hot shape when compared to being in its cold shape.

32. The method of claim 29, wherein the at least one securing element is arranged between the socket housing and an outer side of at least one lamella of the lamella pair, and the method further comprises:
expanding the at least one securing element in a direction between the socket housing and the at least one lamella in response to its transition temperature being reached.

33. The method of claim 29, wherein for each lamella of the lamella pair, multiple securing elements are arranged in series between the socket housing and a lamella of the lamella pair, and wherein the method further comprises:
bringing the multiple securing elements to their respective transition temperatures.

34. The method of claim 33, wherein at least two of the multiple securing elements arranged in series have different transition temperatures.

35. A method for operating an electrical plug-in connection according to claim 22 comprising:
plugging in a first plug-in connection element into a second plug-in connection element, such that two arms of a blade of the first plug in connection element are in a contact state;
bringing an at least one securing element made of a shape memory alloy to its transition temperature;
deforming the at least one securing element from a cold shape to a hot shape in response to the at least one securing element reaching its transition temperature; and
pressing, by the at least one securing element, the arms of the blade apart in response to the at least one securing element being in its hot shape.
